(19) United States
(12) Patent Application Publication
(10) Pub. No.: US 2017/0201879 A1
(43) Pub. Date: Jul. 13, 2017

(54) Temporary Disposable Portable Identifier

(71) Applicant: Dell Software, Inc., Round Rock, TX (US)

(72) Inventors: Konstantin A. Vlasenko, Kanata (CA); Vineetha Abraham, Kanata (CA)

(73) Assignee: Dell Software, Inc., Round Rock, TX (US)

(21) Appl. No.: 14/994,328

(22) Filed: Jan. 13, 2016

(51) Int. Cl. H04W 12/06; H04M 7/00

(52) U.S. Cl. CPC H04W 12/06; H04M 7/0012

(57) ABSTRACT

A system, method, and computer-readable medium for performing a temporary disposable portable identifier operation, comprising: requesting a unique identifier from a provider; generating, via a provider, a request to generate a temporary disposable identifier corresponding to a unique identifier; and, providing the temporary disposable identifier corresponding to the unique identifier to a customer, the temporary disposable identifier only being valid for a defined amount of time, after which the temporary disposable identifier expires.

### BACKGROUND OF THE INVENTION

Field of the Invention

The present invention relates to information handling systems. More specifically, embodiments of the invention relate to performing a temporary disposable portable identifier operation.

Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to communicate with various components of information handling systems via application programming interfaces (APIs). Often, when communicating using APIs such as communicating with a cloud service, an API client might need to specific a unique API token which is provided by the cloud service with which the API client is communicating. This process is often referred to as single-factor authentication for API request. Examples of cloud services which provide a unique API token include Web Services available from Amazon, Inc., Azure Web Services available from Microsoft, Inc., and Pivotal Tracker available from Pivotal Labs. When using an API token, a user copies the API Token from their profile page and pastes the token to a client application (e.g. a Windows PowerShell for Amazon Web Services (AWS) application). However, entering this API token to a mobile application which requires API access (e.g., an AWS mobile application, a Pivotal Tracker mobile application) can be challenging. For example, a user may copy an API token and send the API token to themselves via email. The user can then open the email via their mobile device and copy and paste the API token to the mobile application. However, such a process can be unsecure and inconvenient.

A similar issue is often present when a user accesses a cloud service via a mobile device where the cloud service requires a unique identifier for the mobile device. For example, when accessing a cloud service such as the AWS Cognito cloud service, a mobile device is assigned a unique identifier as soon as the mobile device accesses the cloud service (even anonymously) for the first time. When accessing the same cloud service via another information handling system such as a desktop information handling system, the cloud service may ask the user for this unique identifier so that the desktop information handling system can access data via the cloud service. In certain situations, the data eventually will be available only for a particular mobile device (i.e., a mobile device having the unique identifier provided by the user).

### SUMMARY OF THE INVENTION

A system, method, and computer-readable medium are disclosed for performing a temporary disposable portable identifier operation. In certain embodiments, the temporary disposable portable identifier operation makes use of a universal link cloud service, a unique identifier provider and a unique identifier consumer. In operation, the universal link cloud service provides a service which translates a unique identifier to a temporary simple representation (e.g., a set of easy to read and remember alphanumeric characters). In certain embodiments, the set of easy to read and remember alphanumeric characters comprises three alphanumeric characters. In certain embodiments, the set of easy to read and remember alphanumeric characters comprises a three digit number in the range of 000-999. Because the set of easy to read and remember alphanumeric characters are temporary and disposable, the same set of easy to read and remember alphanumeric characters are regularly available for reuse. For example, in certain embodiments, the set of easy to read and remember alphanumeric characters are available for reuse after a short time period (e.g., after three minutes). More specifically, after the short period of time, the universal link cloud service disposes of the particular instantiation of the alphanumeric characters and makes this particular combination of alphanumeric characters available for reuse. In certain embodiments the unique identifier comprise an API token.

Accordingly, the temporary disposable portable identifier operation converts often difficult to read data used with mobile devices to a temporary disposable simple representation (e.g., a three digit temporary disposable number). Such a temporary disposable portable identifier operation is advantageous when passing an API Token (i.e., a secure key) from a first information handling system application (e.g., a browser application) to a second application which is executing on a different device than the first information handling system application (e.g., a mobile application executing on a mobile device). Such a temporary disposable portable identifier operation is also advantageous when passing a mobile device unique identifier from a mobile device to an information handling system application executing on a different device (e.g., an application executing on a device other than the mobile device having the unique identifier).

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a flow chart of a temporary disposable identifier operation.

FIG. 3 shows an example user interface for performing an aspect of temporary disposable identifier operation.

FIG. 4 shows a block diagram of an example of a cloud services temporary disposable identifier repository.

FIG. 5 shows an example mobile device with an example user interface for performing an aspect of temporary disposable identifier operation.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

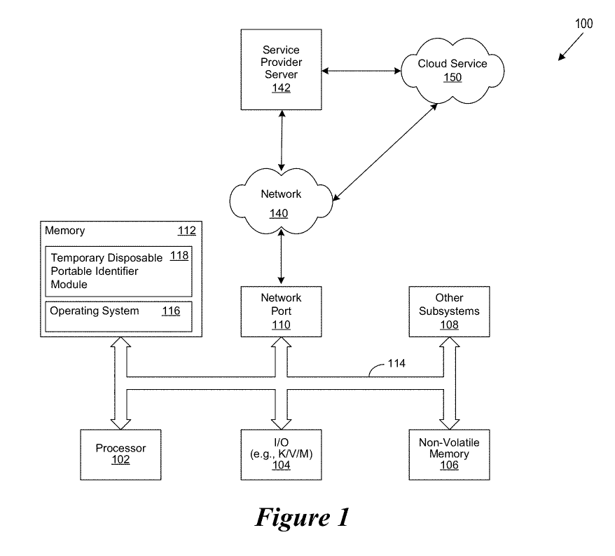

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a temporary disposable portable identifier module 118. In certain embodiments, the information handling system 100 may communicate with a cloud service 150 via the network 140 and/or the service provider 152.

The temporary disposable portable identifier module 118 performs a temporary disposable portable identifier operation. In certain embodiments, the temporary disposable portable identifier operation makes use of a universal link cloud service, a unique identifier provider and a unique identifier consumer. In operation, the universal link cloud service provides a service which translates a unique identifier to a temporary simple representation (e.g., a set of easy to read and remember alphanumeric characters). In certain embodiments, the set of easy to read and remember alphanumeric characters comprises three alphanumeric characters. In certain embodiments, the set of easy to read and remember alphanumeric characters comprises a three digit number in the range of 000-999. Because the set of easy to read and remember alphanumeric characters are temporary and disposable, the same set of easy to read and remember alphanumeric characters are regularly available for reuse. For example, in certain embodiments, the set of easy to read and remember alphanumeric characters are available for reuse after a short time period (e.g., after three minutes). More specifically, after the short period of time, the universal link cloud service disposes of the particular instantiation of the alphanumeric characters and makes this particular combination of alphanumeric characters available for reuse. In certain embodiments the unique identifier comprise an API token.

The temporary disposable portable identifier operation converts often difficult to read data used with mobile devices to a temporary disposable simple representation (e.g., a three digit temporary disposable number). Such a temporary disposable portable identifier operation is advantageous when passing an API Token (i.e., a secure key) from a first information handling system application (e.g., a browser application) to a second application which is executing on a different device than the first information handling system application (e.g., a mobile application executing on a mobile device). Such a temporary disposable portable identifier operation is also advantageous when passing a mobile device unique identifier from a mobile device to an information handling system application executing on a different device (e.g., an application executing on a device other than the mobile device having the unique identifier).

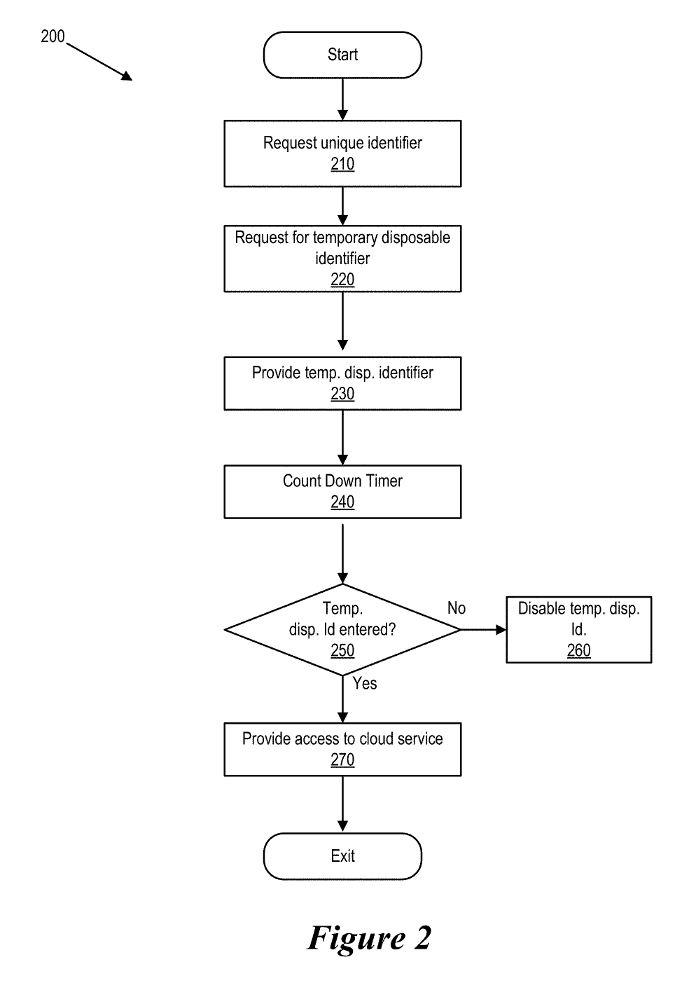

Referring to FIG. 2, a flow chart of a temporary disposable identifier operation 200 is shown. More specifically, the temporary disposable identifier operation 200 begins at step 210 with a customer requesting a unique identifier from a provider. Next, at step 220, the provider generates a request to a cloud service such as a universal link cloud service to generate a temporary disposable identifier corresponding to a unique identifier. In certain embodiments, the unique identifier comprise a cloud service API token. Next at step 230, the temporary disposable identifier is provided to the customer either instead of or in addition to the unique identifier generated by the cloud service. Upon provision of the temporary disposable identifier to the customer a count down timer is started at step 240. Next, at step 250, the temporary disposable identifier operation 200 determines when the customer has entered the temporary disposable identifier to a consumer application. If the disposable identifier is not entered before the count down time reaches the end of its count down, the temporary disposable identifier is disabled within the cloud server at step 260. If the disposable identifier is entered before the count down time reaches the end of its count down, then the customer is provided with access to the cloud service at step 270. During the access to the cloud service, the cloud service provides the unique identifier corresponding to the temporary disposable identifier to the consumer application and the temporary disposable identifier operation 200 completes operation.

In certain embodiments, the temporary disposable identifier operation 200 may further include a step of performing a feedback loop where an internet protocol (IP) address of the consumer application is provided to the provider so that the consumer can confirm receipt of the unique identifier.

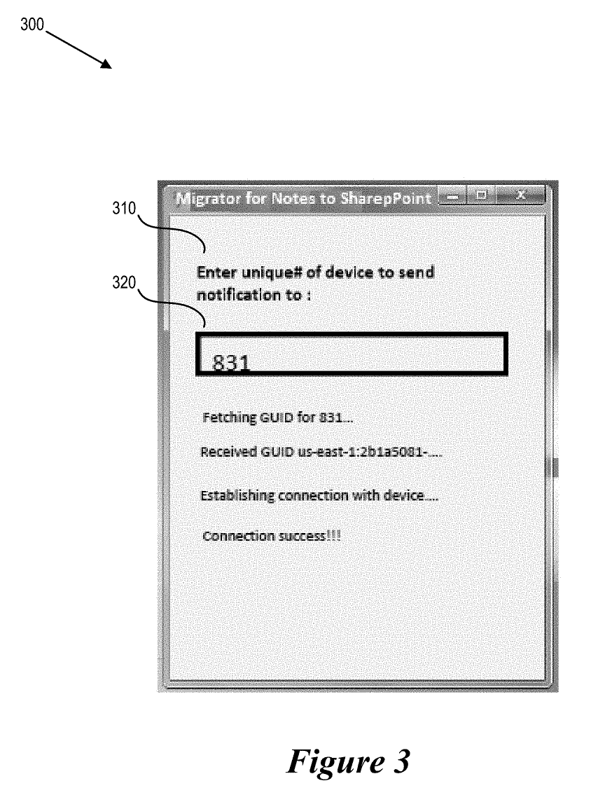

FIG. 3 shows an example user interface 300 for performing an aspect of temporary disposable identifier operation. More specifically, the user interface 300 presents a user interface such as would be presented within a consumer application when attempting to obtain a unique identifier. More specifically, upon being prompted via a prompt 310, a user enters a temporary disposable identifier 320. In various embodiments, the user interface 300 provides an indication that a unique identifier corresponding to the temporary disposable identifier is being fetched. In various embodiments, the user interface 300 provides an indication when the unique identifier corresponding to the temporary disposable identifier is received. In various embodiments, the user interface 300 provides an indication a connection was successfully achieved.

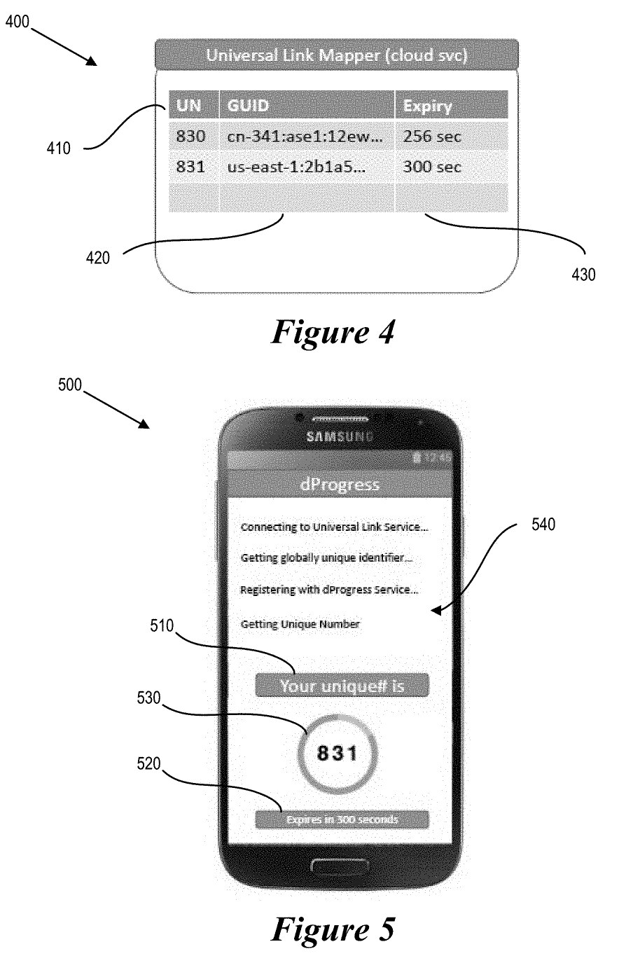

FIG. 4 shows a block diagram of an example of a cloud services temporary disposable identifier repository 400. More specifically, the cloud services temporary disposable identifier repository 400 comprises and an expiration time portion 430. The temporary disposable identifier portion 410 stores one or more temporary disposable identifiers. The unique identifier portion 420 stores one or more respective unique identifiers corresponding to respective temporary disposable identifiers. The expiration time portion 430 maintains an expiation count down for each temporary disposable identifier. Upon expiration of the count down, the temporary disposable identifier and the respective unique identifier are removed from the cloud services temporary disposable identifier repository 400.

FIG. 5 shows an example mobile device 500 with an example user interface 502 for performing an aspect of temporary disposable identifier operation. More specifically, the user interface 502 presents a user interface such as would be presented within a mobile application when attempting to obtain a unique identifier. More specifically, the user interface 502 presents a temporary disposable identifier 510 along with an indication of when the temporary disposable identifier expires 520. Additionally, in certain embodiments the user interface 502 further presents a count down indication 530 such as a rotating portion within a circle to visually indicate how much time is left before the temporary disposable identifier expires. Additionally, in certain embodiments, the user interface 502 includes an information portion 540 which presents a user with various information regarding the obtaining of the temporary disposable identifier. For example, the information portion 540 can include one or more of an indication that the mobile device is connecting to a cloud service, an indication that a unique identifier is being obtained, an indication that the mobile application is registering with the cloud service and a status regarding obtaining the unique identifier.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a temporary disposable portable identifier operation, comprising:
requesting a unique identifier from a provider;
generating, via a provider, a request to generate a temporary disposable identifier corresponding to a unique identifier; and,
providing the temporary disposable identifier corresponding to the unique identifier to a customer, the temporary disposable identifier only being valid for a defined amount of time, after which the temporary disposable identifier expires.

2. The method of claim 1, wherein:
the unique identifier is generated by a cloud service.

3. The method of claim 1, wherein:
the requesting is via a first device; and further comprising
determining when the customer has entered the temporary disposable identifier to a consumer application, the consumer application executing on a device other than the first device.

4. The method of claim 1, wherein:
the temporary disposable identifier comprises a set of easy to read and remember alphanumeric characters.

5. The method of claim 4, wherein:
the temporary disposable identifier comprises three digit number in the range of 000-999.

6. The method of claim 1, wherein:
the unique identifier comprises a cloud service API token.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
requesting a unique identifier from a provider;
generating, via a provider, a request to generate a temporary disposable identifier corresponding to a unique identifier; and,
providing the temporary disposable identifier corresponding to the unique identifier to a customer, the temporary disposable identifier only being valid for a defined amount of time, after which the temporary disposable identifier expires.

8. The system of claim 7, wherein:
the unique identifier is generated by a cloud service.

9. The system of claim 7, wherein:
the requesting is via a first device; and the instructions further comprising
determining when the customer has entered the temporary disposable identifier to a consumer application, the consumer application executing on a device other than the first device.

10. The system of claim 7, wherein:
the temporary disposable identifier comprises a set of easy to read and remember alphanumeric characters.

11. The system of claim 10, wherein:
the temporary disposable identifier comprises three digit number in the range of 000-999.

12. The system of claim 7, wherein:
the unique identifier comprises a cloud service API token.

13. A non-transitory, computer-readable storage medium embodying computer program code, the computer program code comprising computer executable instructions configured for:
requesting a unique identifier from a provider;
generating, via a provider, a request to generate a temporary disposable identifier corresponding to a unique identifier; and,
providing the temporary disposable identifier corresponding to the unique identifier to a customer, the temporary disposable identifier only being valid for a defined amount of time, after which the temporary disposable identifier expires.

14. The non-transitory, computer-readable storage medium of claim 13, wherein:
the unique identifier is generated by a cloud service.

15. The non-transitory, computer-readable storage medium of claim 13, wherein:
the requesting is via a first device; and the instructions further comprising
determining when the customer has entered the temporary disposable identifier to a consumer application, the consumer application executing on a device other than the first device.

16. The non-transitory, computer-readable storage medium of claim 13, wherein:
the temporary disposable identifier comprises a set of easy to read and remember alphanumeric characters.

17. The non-transitory, computer-readable storage medium of claim 16, wherein:
the temporary disposable identifier comprises three digit number in the range of 000-999.

18. The non-transitory, computer-readable storage medium of claim 13, wherein:
the unique identifier comprises a cloud service API token.
